(19) United States
(12) Patent Application Publication
(10) Pub. No.: US 2008/0260328 A1
(43) Pub. Date: Oct. 23, 2008

(54) LED LIGHT EXTRACTION BAR AND INJECTION OPTIC FOR THIN LIGHTGUIDE

(75) Inventor: Kenneth A. Epstein, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/738,172

(22) Filed: Apr. 20, 2007

(51) Int. Cl. G02B 6/26

(52) U.S. Cl. 385/32; 385/31

(57) ABSTRACT

An optical system for back-illuminating a display has a lightguide having a confinement direction and a first plurality of light sources disposed proximate a first edge of the lightguide. Light from at least one of the light sources defines an emission axis which is approximately parallel to the confinement direction. A solid light injector is disposed to couple light from the light sources into the lightguide. A surface of the light injector may be shaped as a confinement curve for confining light from the first plurality of light sources in the confinement direction by total internal reflection. In some embodiments a portion of the illumination light from the one or more light sources enters the first light injector along a direction having a component directed away from the lightguide and is totally internally reflected within the injector.

### FIELD OF THE INVENTION

The invention relates to lightguides that are used, for example, for illuminating a display, and more particularly to methods and devices for injecting light into the lightguides from light emitting diodes.

### BACKGROUND

The light emitting diode (LED) first gained entry to backlighting liquid crystal displays (LCDs) in small handheld displays. Such backlights typically comprise a lightguide with one or more white LEDs configured to inject light into one edge or one corner of the lightguide. Surface mount side-emitting LEDs for handheld backlights typically have an emission aperture 0.6 to 0.8 mm in height. Thus, the thinnest lightguide that will accept all of the light is 0.6 mm or thicker.

In a handheld backlight the LED package is oriented beside the input edge of the lightguide and the light is coupled through air from the LED to the lightguide. An optical scattering surface is patterned on the bottom of the lightguide to extract light by directing the light upwards to the liquid crystal panel. Up to 90% of the light incident on the lightguide input edge refracts from air into the lightguide. However, the optical spread angle for propagation in the plane of the lightguide is limited by the critical angle of light in the lightguide. Thus, the light that enters through the edge of a lightguide spreads out within the lightguide with a half angle of 42° with respect to the normal to the edge of the lightguide. Therefore, the light spreads weakly and uniformity suffers.

Many handheld lightguides are manufactured with a structured input edge. The structure is typically a micro-columnar lens, prism, or other lenticular grooves running from the top surface to the bottom surface of the lightguide. Such grooves tend to spread light into a propagation cone wider than the critical angle, but still less than 90-degrees. Hence, the need still exists for greater propagation divergence in the lightguide.

Recently, implementation of solid state lighting began transitioning to larger displays, such as notebooks, monitors, and TVs with either white LEDs or RGB LEDs. In each instance, from handheld up to the largest TVs, the backlight is built to accommodate a large LED package with a substantial encapsulant optic. The accommodation typically results in a thick backlight and a large region dedicated to mixing the light from individual LEDs into homogeneous white light. In particular, edgelit displays require a mixing region up to 100 mm long. Thus, a substantial portion of the backlight must extend beyond the display area within a wide bezel or it may fold under the display area so as to ensure that the mixing region lies outside the viewing area of the display.

Four deficiencies of conventional approaches may be summarized as:
1. Air-coupling from the LED package into the lightguide restricts the angles of injected light to a propagation cone bounded by the critical angle of the lightguide, therefore, the light mixing region in the lightguide is lengthened.
2. The standard LED packages are large; therefore the emitted light does not couple efficiently into a thin lightguide.
3. The refractive index of the encapsulant is typically much lower than that of the emissive LED die; therefore the extraction of light from the die is inefficient.
4. The LED lies in a plane that is parallel to the input edge of the lightguide. This orientation is perpendicular to the PC board to which the LED is attached. As a result, conductive heat extraction is limited and difficult to implement.

### SUMMARY OF THE INVENTION

One embodiment of the invention is directed to an optical system that has a lightguide having a confinement direction and a first plurality of light sources disposed proximate a first edge of the lightguide. Light from at least a first light source of the first plurality of light source is directed substantially around an emission axis, the emission axis being approximately parallel to the confinement direction. There is a solid first light injector disposed to couple light from the first plurality of light sources into the lightguide. The first light injector has a first surface, at least a first portion of the first surface being shaped as a confinement curve for confining light from the first plurality of light sources in the confinement direction by total internal reflection.

Another embodiment of the invention is directed to an optical system that has a lightguide having a confinement direction and a first plurality of light sources capable of emitting light generally about respective emission axes parallel to the confinement direction. A first, non-reflectorized light injector is disposed to couple light from the first plurality of light sources to the lightguide, the first injector directing the light from the first plurality of light sources to the lightguide.

Another embodiment of the invention is directed to an optical system that has a lightguide defining a confinement direction and a first set of one or more light sources capable of generating illumination light. A solid first light injector is disposed to couple light from the one or more light sources to the lightguide. At least a first portion of the illumination light from the one or more light sources enters the first light injector along a direction having a component directed away from the lightguide. The first portion of the illumination light is totally internally reflected within the injector.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 schematically illustrates an embodiment of a display system having an edge-lit backlight, according to principles of the present invention;

FIG. 2 schematically illustrates an exemplary embodiment of a confinement curve injector according to principles of the present invention;

FIG. 3 is a graph showing different critical curve shapes for exemplary injectors formed of material of different refractive index;

FIGS. 4, 5A and 5B schematically illustrate additional exemplary embodiments of confinement curve injectors according to principles of the present invention;

FIG. 6 presents a graph showing calculated losses and injection efficiency for coupling light from a light emitting diode (LED) into a lightguide using a confinement curve injector according to principles of the present invention;

FIGS. 7A and 7B present graphs showing flux profile as a function of position across a lightguide, for various embodiments of illumination unit that use an injector for injecting light from LEDs into a lightguide, according to principles of the present invention;

FIGS. 8A and 8B schematically illustrate plan views of different embodiments of confinement curve injectors according to principles of the present invention; and

FIGS. 9A-9C schematically illustrate different approaches for optically coupling light from an LED into a confinement curve injector according to principles of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is applicable to optical systems and is more particularly applicable to optical display systems in which the display panel is illuminated from behind using a lightguide. In such displays, the light source or sources, is placed to the side of the display panel and the lightguide is used to transport the light from the light source(s) to positions behind the display panel. The invention relates to an approach for coupling light into the lightguide from a light source, such as a light emitting diode (LED).

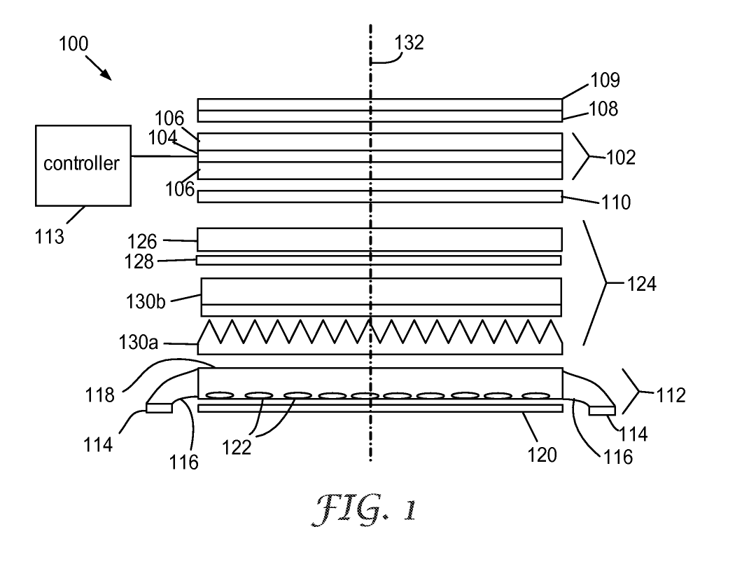

A schematic exploded view of an exemplary embodiment of an edge-lit display device 100 is presented in FIG. 1. In this exemplary embodiment, the display device 100 uses a liquid crystal (LC) display panel 102, which typically comprises a layer of LC 104 disposed between panel plates 106. The plates 106 are often formed of glass, or another stiff material, and may include electrode structures and alignment layers on their inner surfaces for controlling the orientation of the liquid crystals in the LC layer 104. The electrode structures are commonly arranged so as to define LC panel pixels, areas of the LC layer where the orientation of the liquid crystals can be controlled independently of adjacent pixels. A color filter may also be included with one or more of the plates 106 for imposing color on the displayed image.

An upper absorbing polarizer 108 is positioned above the LC layer 104 and a lower absorbing polarizer 110 is positioned below the LC layer 104. In the illustrated embodiment, the upper and lower absorbing polarizers 108, 110 are located outside the LC panel 102. The absorbing polarizers 108, 110 and the LC panel 102, in combination, control the transmission of light from backlight 112 through the display 100 to the viewer. In some exemplary embodiments, when a pixel of the LC layer 104 is not activated, it does not change the polarization of light passing therethrough. Accordingly, light that passes through the lower absorbing polarizer 110 is absorbed by the upper absorbing polarizer 108, when the absorbing polarizers 108, 110 are aligned perpendicularly. When the pixel is activated, on the other hand, the polarization of the light passing therethrough is rotated, so that at least some of the light that is transmitted through the lower absorbing polarizer 110 is also transmitted through the upper absorbing polarizer 108. Selective activation of the different pixels of the LC layer 104, for example by a controller 113, results in the light passing out of the display at certain desired locations, thus forming an image seen by the viewer. The controller 113 may include, for example, a computer or a television controller that receives and displays television images. One or more optional layers 109 may be provided over the upper absorbing polarizer 108, for example to provide mechanical and/or environmental protection to the display surface. In one exemplary embodiment, the layer 109 may include a hardcoat over the absorbing polarizer 108.

Some types of LC displays may operate in a manner different from that described above and, therefore, differ in detail from the described system. For example, the absorbing polarizers may be aligned parallel and the LC panel may rotate the polarization of the light when in an unactivated state. Regardless, the basic structure of such displays remains similar to that described above.

The backlight 112 comprises one or more light sources 114 that generate the illumination light and direct the illumination light into a lightguide 118. The light sources 114 may be, for example, light emitting diodes (LEDs). Light from the light sources 114 may be coupled into a lightguide 118 by an injector 116, which is described in greater detail below. The lightguide 118 guides illumination light from the light sources 114 to an area behind the display panel 102, and directs the light to the display panel 102. The lightguide 118 may receive illumination light through one or more edges, one or more corners, or a combination of edges and corners.

A base reflector 120 may be positioned on the other side of the lightguide 118 from the display panel 102. The lightguide 118 may include light extraction features 122 that are used to extract the light from the lightguide 118 for illuminating the display panel 102. For example, the light extraction features 122 may comprise diffusing spots on a surface of the lightguide 118 that direct light either directly towards the display panel 102 or towards the base reflector 120. Other approaches may be used to extract the light from the lightguide 118.

The base reflector 120 may also be useful for recycling light within the display device 100, as is explained below. The base reflector 120 may be a specular reflector or may be a diffuse reflector.

An arrangement of light management layers 124 may be positioned between the backlight 112 and the display panel 102 for enhanced performance. For example, the light management layers 124 may include a reflective polarizer 126. The light sources 116 typically produce unpolarized light but the lower absorbing polarizer 110 only transmits a single polarization state, and so about half of the light generated by the light sources 116 is not suitable for transmission through to the LC layer 104. The reflecting polarizer 126, however, may be used to reflect the light that would otherwise be absorbed in the lower absorbing polarizer 110, and so this light may be recycled by reflection between the reflecting polarizer 126 and the base reflector 120. At least some of the light reflected by the reflecting polarizer 126 may be depolarized and subsequently returned to the reflecting polarizer 126 in a polarization state that is transmitted through the reflecting polarizer 126 and the lower absorbing polarizer 110 to the LC panel 102. In this manner, the reflecting polarizer 126 may be used to increase the fraction of light emitted by the light sources 116 that reaches the LC panel 102, and so the image produced by the display device 100 is brighter.

Any suitable type of reflective polarizer may be used, for example, multilayer optical film (MOF) reflective polarizers; diffusely reflective polarizing film (DRPF), such as continuous/disperse phase polarizers; wire grid reflective polarizers or cholesteric reflective polarizers.

Both the MOF and continuous/disperse phase reflective polarizers rely on the difference in refractive index between at least two materials, usually polymeric materials, to selectively reflect light of one polarization state while transmitting light in an orthogonal polarization state. Some examples of MOF reflective polarizers are described in co-owned U.S. Pat. No. 5,882,774, incorporated herein by reference. Commercially available examples of MOF reflective polarizers include Vikuititm DBEF-D200 and DBEF-D400 multilayer reflective polarizers that include diffusive surfaces, available from 3M Company, St. Paul, Minn.

Examples of DRPF useful in connection with the present invention include continuous/disperse phase reflective polarizers as described in co-owned U.S. Pat. No. 5,825,543, incorporated herein by reference, and diffusely reflecting multilayer polarizers as described in e.g. co-owned U.S. Pat. No. 5,867,316, also incorporated herein by reference. Other suitable types of DRPF are described in U.S. Pat. No. 5,751,388.

Some examples of wire grid polarizers useful in connection with the present invention include those described in U.S. Pat. No. 6,122,103. Wire grid polarizers are commercially available from, inter alia, Moxtek Inc., Orem, Utah.

Some examples of cholesteric polarizer useful in connection with the present invention include those described in, for example, U.S. Pat. No. 5,793,456, and U.S. Patent Publication No. 2002/0159019. Cholesteric polarizers are often provided along with a quarter wave retarding layer on the output side, so that the light transmitted through the cholesteric polarizer is converted to linear polarization.

A polarization mixing layer 128 may be placed between the backlight 112 and the reflecting polarizer 126 to aid in mixing the polarization of the light reflected by the reflecting polarizer 126. For example, the polarization mixing layer 128 may be a birefringent layer such as a quarter-wave retarding layer.

The light management layers 124 may also include one or more prismatic brightness enhancing layers 130a, 130b. A prismatic brightness enhancing layer is one that includes a surface structure that redirects off-axis light into a propagation direction closer to axis 132 of the display device 100. This controls the viewing angle of the illumination light passing through the display panel 102, typically increasing the amount of light propagating on-axis through the display panel 102. Consequently, the on-axis brightness of the image seen by the viewer is increased.

One example of a brightness enhancing layer has a number of prismatic ridges that redirect the illumination light, through a combination of refraction and reflection. Examples of prismatic brightness enhancing layers that may be used in the display device include the Vikuiti™ BEFII and BEFIII family of prismatic films available from 3M Company, St. Paul, Minn., including BEFII 90/24, BEFII 90/50, BEFIIIM 90/50, and BEFIIIT. Although only one brightness enhancing layer may be used, two brightness enhancing layers 130a, 130b may be used, with their structures oriented at about 90° to each other. This crossed configuration provides control of the viewing angle of the illumination light in two dimensions, the horizontal and vertical viewing angles.

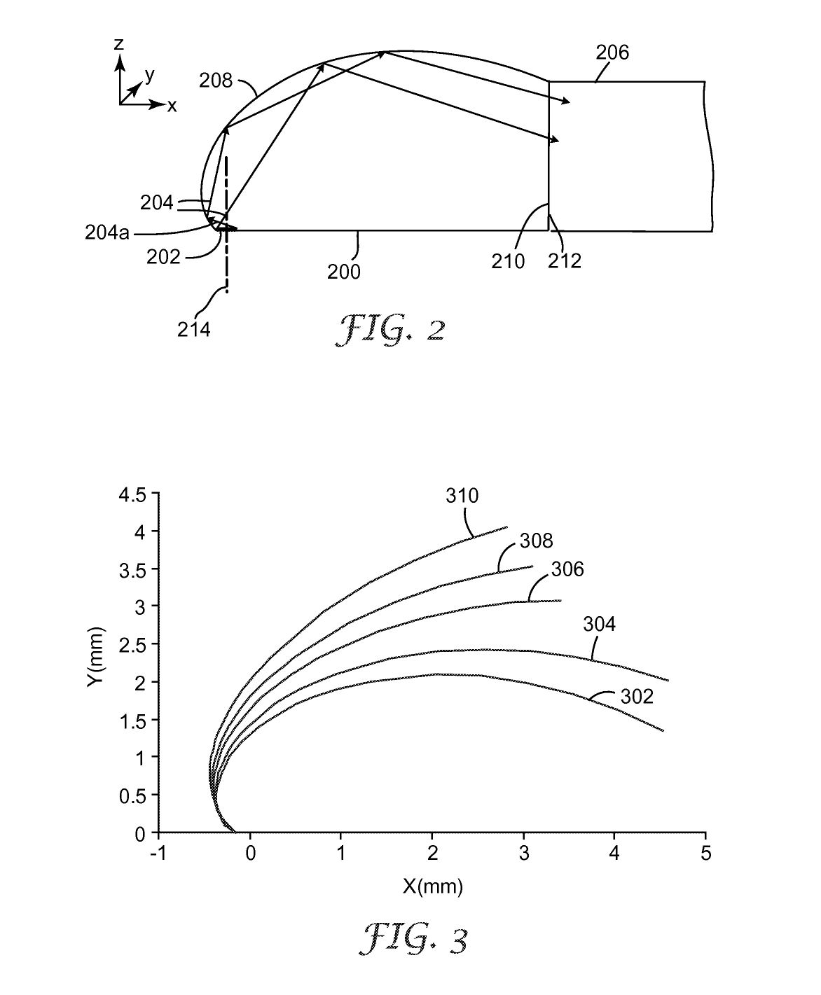

An exemplary embodiment of a solid light injector 200 is schematically illustrated in FIG. 2. The injector 200 includes an upper surface 208. A light source 202, such as a light emitting diode (LED), emits light 204 into the solid injector 200. The light is totally internally reflected by the upper surface 208 of the injector 200 and is directed into the edge of the lightguide 206. At least some of the upper surface 208 of the injector 200 is shaped with a confinement curve, i.e. a curve that provides total internal reflection for all light incident on the surface from all points of the emitting surface of the LED 202. The curve of the surface 208 follows the critical line for light emitted from the far edge of the LED die 202. The surface may be considered to be incrementally built from line segments beginning at the lower left by forcing the segments to tilt at an angle just within the critical angle for light emitted from the right corner of the LED die 202. The length of each segment may be made to be short enough such that a continuous curve is approximated. Light emitted from the emitting surface of the LED 202 die is totally internally reflected within the injector 200 using this procedure. Thus, ray 204a, which is originally emitted in a direction that has a component in the direction away from the lightguide 206, i.e. has a component in the negative x-direction, is totally internally reflected back towards the lightguide. In other words, the light 204a is turned around from having a component in the negative x-direction to a component in the positive x-direction. The injector 200 may be non-reflectorized, i.e. may be lacking any reflective coatings for reflecting the light from the LED die 202 to the lightguide 206.

In the figure, the coordinate system is such that the plane of the figure lies in the x-z plane, and the y-direction lies into the plane of the figure.

The injector 200 may be made from any suitable transparent material. Some exemplary suitable glass materials include optical glasses such as Schott glass type LASF35 or N-LAF34, available from Schott North America Inc., and those described in U.S. patent application Ser. No. 11/381,518, incorporated herein by reference. Other suitable inorganic materials include ceramics such as sapphire, zinc oxide, zirconium oxide and silicon carbide. Examples of suitable organic materials include polymers such as acrylics, epoxies, silicones, polycarbonates, and cyclic olefins. Polymeric materials may include dopants, for example ceramic nanoparticles as discussed in U.S. Provisional Patent Application Ser. No. 60/866,280, filed Nov. 17, 2006. This list of materials is not intended to be exhaustive and other types of glasses, ceramics and polymers may also be used.

The injector 200 may be optically coupled to the lightguide 206 using various different suitable methods. For example, the output surface 210 of the injector 200 may be placed in optical contact with the edge 212 of the lightguide 206. In other embodiments, an intermediate coupling material (not shown) may be placed between the injector 200 and the lightguide 206. One example of an intermediate coupling material is an adhesive used for attaching the injector 200 to the lightguide 208.

The lightguide 206 confines light in the vertical direction, i.e. the z-direction. The LED 202 has an illumination axis 214, which denotes the average direction of propagation of the light that is emitted from the LED 202. Where the LED 202 has a planar emitting surface, the illumination axis is generally perpendicular to the planar emitting surface.

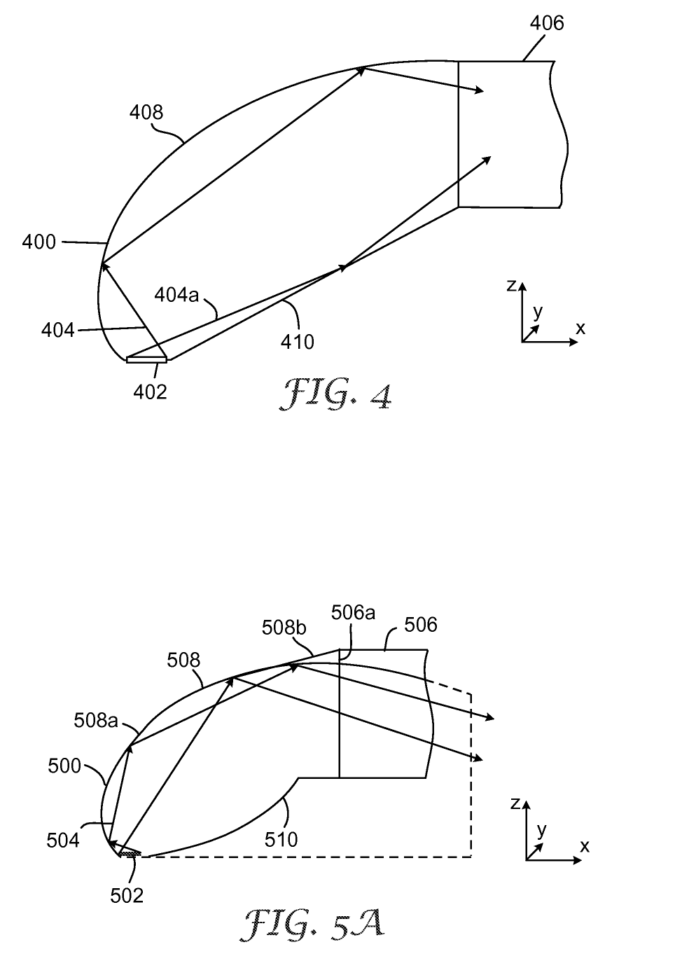

The shape of the confinement curve is determined, in part by the refractive index of the material used for the injector 200. Some different examples of critical curves are shown in the graph in FIG. 3. The curves 302, 304, 306, 308 and 310 respectively represent the critical curves for an injector having a refractive index of 1.6, 1.5, 1.4, 1.35, 1.3 respectively. These critical curves were modeled for an LED light emitting surface that was centered at the origin and was square with a 300 μm side. As can be seen, the critical curves are tighter for higher values of refractive index.

The lowest angle of incidence of light on a critically curved surface from the light emitting surface of the LED is the critical angle for total internal reflection. The term “confinement curve” is understood to include critical curves, but may be shaped so that the minimum angle of incidence of light from the LED is at an angle greater than the critical angle.

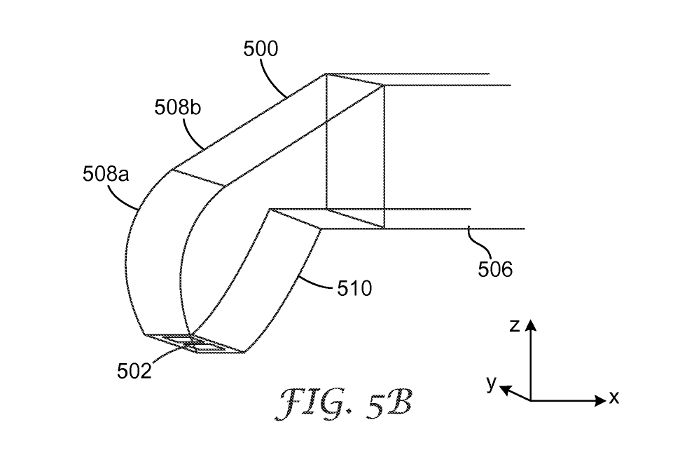

Another embodiment of injector 400 is schematically illustrated in FIG. 4. The injector 400 is used for coupling light 404 from one or more LEDs 402 to a lightguide 406. The upper surface 408 of the injector 400 is formed with at least a portion having the shape of a confinement curve. The lower surface 410 is angled so as to be non-parallel to the x-y plane. Light 404a incident on the lower surface 410 is totally internally reflected and directed to the lightguide 404. This embodiment permits the injector to couple to a thinner lightguide 404 than the embodiment illustrated in FIG. 2. The lower surface 410 may be a flat surface and may be oriented at any suitable angle. For example, an angle, θ, of around 27° has been shown to be suitable in modeling for coupling light from LEDs having a 300 μm square emitting surface, although other angles may also be used. In other embodiments, the lower surface 410 may be curved, for example with a parabolic or other smooth curve, or may take on some other shape.

Another embodiment of an injector 500 is schematically illustrated in FIGS. 5A and 5B. The injector 500 is used for coupling light 504 from one or more LEDs 502 to a lightguide 506. The upper surface 508 of the injector 500 is formed with at least a first portion 508a having the shape of a confinement curve and a second portion 508b having some other shape. The shape of the second portion 508b may be flat, as illustrated, or may be curved, for example with a parabolic curve or some other smooth curve, or may take on some other shape. The lower surface 510 is angled relative to the x-y plane. In the illustrated embodiment, the lower surface 510 is parabolically curved, but may take on other shapes, such as other curves, a flat shape or the like.

The figure shows, in dashed lines, a larger injector having only a confinement curve on the upper surface. The injector 500 is smaller than the injector that has only a confinement curve on its upper surface, and so may be made more compact and may be used for coupling to a thinner lightguide.

An injector of the type shown in FIGS. 5A and 5B was modeled to calculate the efficiency of injection. The first portion 508a of the upper surface was a confinement curve that was assumed to be a critical curve for a refractive index of 1.7. The second portion 508b of the upper surface was assumed to be flat. The lower surface 510 was assumed to be parabolic. The LEDs 502 were assumed to have a square emitting area having a side of 300 μm. The lightguide 506 was assumed to be 0.85 mm thick.

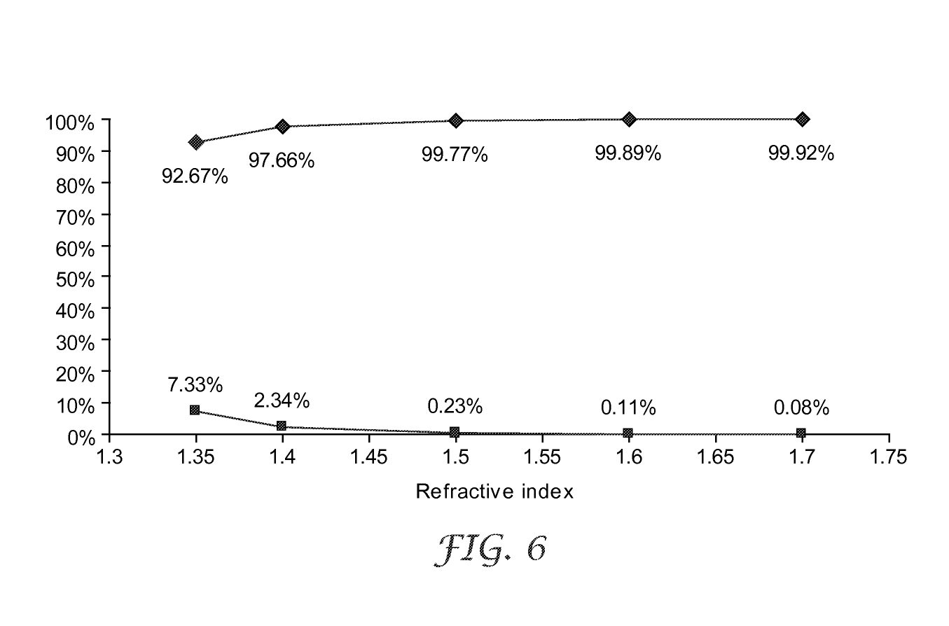

The graph shown in FIG. 6 plots the injection efficiency into the lightguide 506 (upper curve, diamonds) and the leakage from the lightguide 506 (lower curve, squares) due to rays that are not confined by TIR within the lightguide 506. The injection efficiency was modeled as a function of refractive index of the injector material. Thus, light confinement is imperfect within the injection optic for values of refractive index, n₁, less than 1.7. Of course, the injector 500 may be designed with a confinement curve that accommodates the use of an injector material having a lower refractive index.

The model assumed that several LED dies 502 were used along the length of the lightguide, with a center-to-center spacing of 4 mm. The light output from the LEDs was assumed to be Lambertian in profile. The uniformity of the light within the lightguide 506 was studied as a function of distance from the input edge of the lightguide 506.

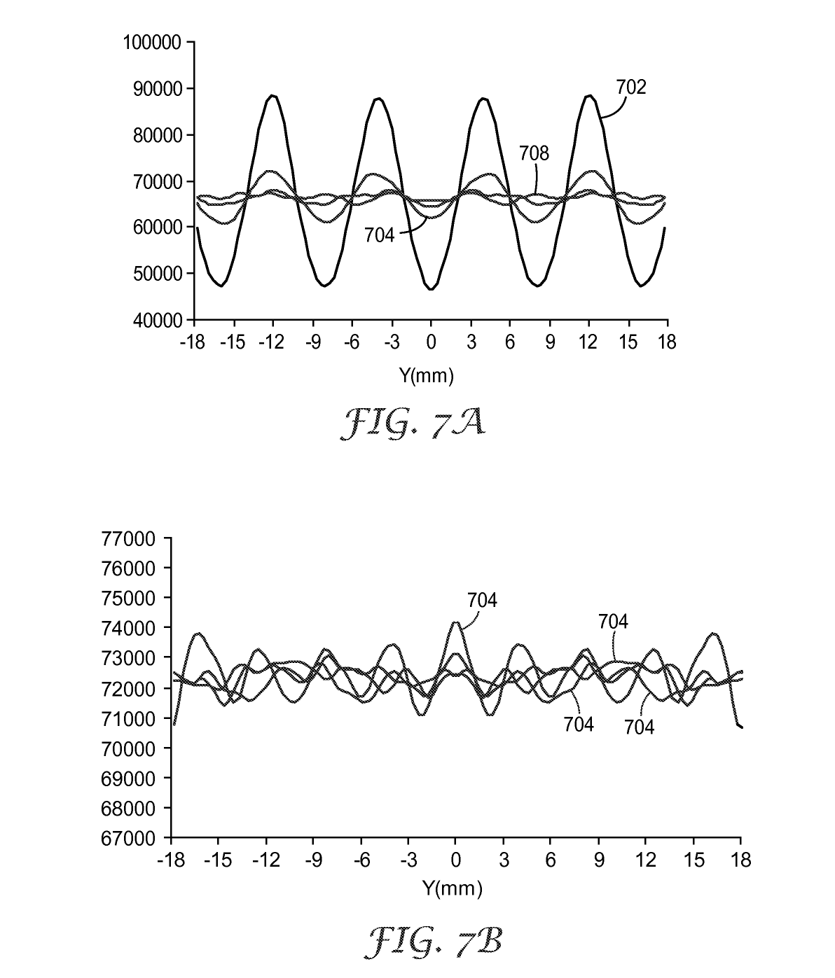

The flux profile was calculated across the lightguide for various distances from the input surface 506a of the light at various positions within the lightguide. The results, shown in FIG. 7A, represent the flux profile at distances 0 mm (curve 702), 1 mm (curve 704), 2 mm (curve 706), and 4 mm (curve 708) from the input surface 506a. As can be seen, the flux profile was highly non-uniform at the input surface 506a. At increased depths into the lightguide, however, the flux profile became much more uniform. At distances of 2 and 4 mm from the input surface 506a, the uniformity was indistinguishable or the non-uniformity was within the noise of the simulation. In this case the lightguide 506 was assumed to have a length of 44 mm and a length of 250 mm. The injector 500 was assumed to have a refractive index of 1.5 and had reflecting surface that was critically curved.

The simulation was repeated, but this time with a center-to-center spacing of 8 mm and a lightguide length of 48 mm. The lightguide is longer than that used to produce the results in FIG. 7B in order to add a distance of one half the die spacing at the two edges of the light guide in order to balance the power across the lightguide. The results are presented in FIG. 7B, where curves 712, 714, 716 and 718 respectively represent the calculated flux at 0 mm, 2 mm, 4 mm and 8 mm. In this case, the flux is slightly more nonuniform at a position 2 mm into the lightguide than the simulation noise.

The modeling was performed with the assumption that the light was monochromatic. The results indicate that monochromatic light spreads and becomes uniform within 1 mm of the lightguide input surface for LEDs spaced 4 mm apart and at about 3 mm for LEDs spaced 8 mm apart. Hence, light injection from white LEDs (LEDs provided with a phosphor to convert the light to additional wavelengths, or groupings of red, green and blue LEDs) or monochromatic LEDs 4 mm spacing or less is uniform within the lightguide at a short distance from the input surface.

The LEDs may be arranged as a repeating color cluster, i.e. a repeating pattern of LEDs that produce differently colored light. The individual colors of the cluster may be treated as monochromatic sources with a center-to-center separation. If the individual colors spread uniformly, then the mixed color resulting from the color cluster will also be uniform.

The dimensions in the examples may be scaled according to the size and separation of the dice.

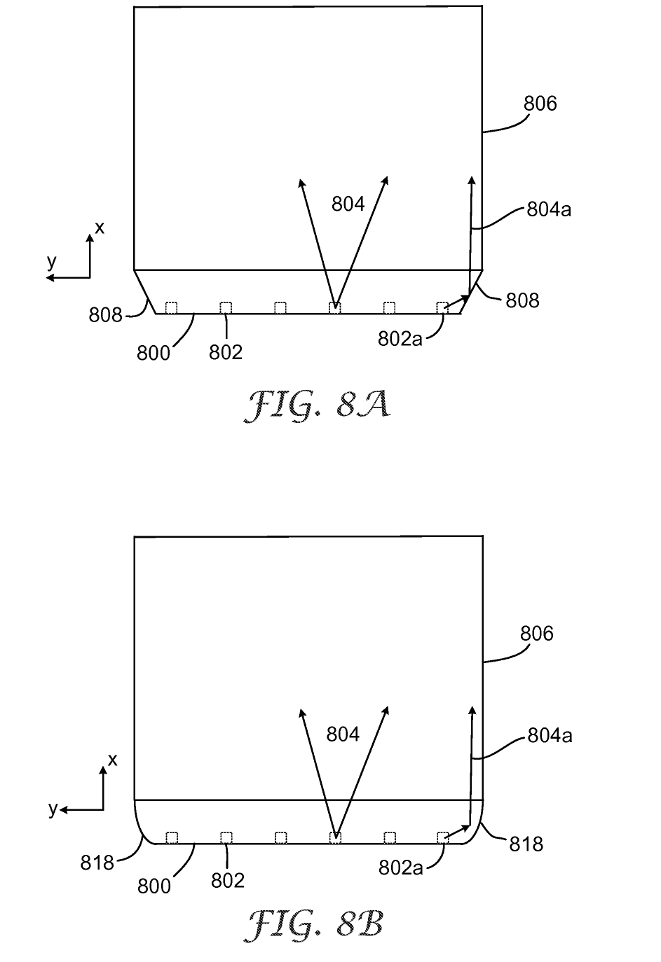

The injector may be further adapted to increase the amount of light coupled into the lightguide. If the end of the injector is square, some light may escape from the injector. To reduce this loss, the ends of the end of the injector may be shaped to reflect light towards the lightguide. One exemplary embodiment of such an injector 800 is schematically illustrated in FIG. 8A, which shows a plan view looking down on the lightguide 806. Light 804 from the LEDs 802 is injected into the lightguide 806 via the injector 800. The axes of the coordinate system in the figure correspond to those of previous figures. The end surfaces 808 of the injector 800 are set at an angle relative to the x-axis, with the result that light 804a from an LED 802a located close to the end of the injector 800 may be totally internally reflected by the injector 800 and directed towards the lightguide 806, instead of being lost out of the end of the injector 800. In the illustrated embodiment, the end surfaces 808 are flat, although this need not be the case and the end surfaces 808 may be curved. For example, in the exemplary embodiment illustrated in FIG. 8B, the end surfaces 818 are provided with confinement curves.

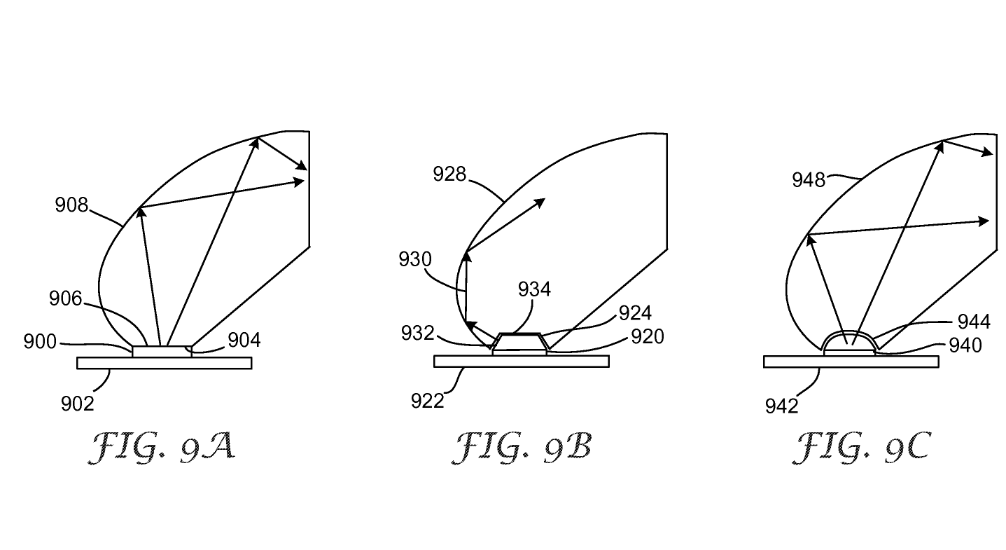

Different arrangements of LEDs may be used with the invention. In some embodiments, the LED is used in die form and has a flat upper surface that emits the generated light. This embodiment is schematically illustrated in FIG. 9A. An LED die 900 is attached to a mount 902 which may be, for example, a circuit board, or may include a submount on a circuit board. Typically, the mount 902 provides electrical power to the LED die 900 and may also provide some thermal management capability. For example, the mount 902 may act as a heatsink, either passive or active, for the LED die 900.

The light emitting surface 904 of the LED die 900 is optically coupled to the input surface 906 of the injector 908. The surface 904 may be simply placed in contact with the input surface 906, or there may be some coupling material between the light emitting surface 904 and the input surface 906. For example, the coupling material may be an adhesive.

Different types of LED die 900 may be used in this embodiment and the embodiments described below. For example, the LED die may be a flip-chip LED die, where both electrical contacts are on the lower surface of the die 900 facing away from the injector 908, or may be a wire-bonded LED die, in which case one of the electrical contacts is on the side of the die 900 facing the injector 908.

In some embodiments, the light may be emitted from an edge of the LED. This situation is schematically illustrated in FIG. 9B. The LED die 920 is attached to a mount 922 and is disposed within a recess 924 of the injector 928. The recess 924 may be shaped to conform to the shape of the LED die 920, although this is not a requirement. In this embodiment, light 930 is emitted from the edge surfaces 932 of the LED die 920, and may also be emitted from the upper surface 934. A coupling material may also be disposed in the recess 924, between the LED die 920 and the recess surface of the injector 928.

In some embodiments, the LED may be encapsulated, rather than being a naked LED die. This situation is schematically illustrated in FIG. 9C, in which the encapsulated LED 940, attached to a mount 942, is disposed at least partially within a recess 944 of the injector 948. The recess 944 may be shaped to conform to the shape of the encapsulant of the LED 940, although this is not a requirement. A coupling material may also be disposed in the recess 944, between the encapsulated LED 940 and the recess surface of the injector 948.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

We claim:

1. An optical system, comprising:
a lightguide having a confinement direction;
a first plurality of light sources disposed proximate a first edge of the lightguide, light from at least a first light source of the first plurality of light source being directed substantially around an emission axis, the emission axis being approximately parallel to the confinement direction; and
a solid first light injector disposed to couple light from the first plurality of light sources into the lightguide, the first light injector having a first surface, at least a first portion of the first surface being shaped as a confinement curve for confining light from the first plurality of light sources in the confinement direction by total internal reflection.

2. A system as recited in claim 1, wherein a second portion of the first surface is straight.

3. A system as recited in claim 1, wherein a second portion of the first surface is curved.

4. A system as recited in claim 3, wherein the second portion of the first surface comprises a parabolic surface.

5. A system as recited in claim 1, wherein a second portion of the first surface comprises a reflectorized surface.

6. A system as recited in claim 1, wherein the first light injector comprises a second surface, at least a portion of the second surface being straight.

7. A system as recited in claim 1, wherein the first light injector comprises a second surface, at least a portion of the second surface being curved.

8. A system as recited in claim 7, wherein the second surface comprises a parabolic surface portion.

9. A system as recited in claim 1, further comprising a second plurality of light sources disposed proximate a second edge of the lightguide and a solid second light injector disposed to couple light from the second plurality of light sources into the lightguide.

10. A system as recited in claim 9, wherein the second light injector has a first surface, at least a first portion of the first surface being shaped as a confinement curve for confining light from the second plurality of light sources in the confinement direction by total internal reflection.

11. A system as recited in claim 1, wherein light is extracted from the lightguide and further comprising a display panel disposed for illumination by the light extracted from the lightguide and a controller coupled to the display panel to control an image displayed by the display panel.

12. A system as recited in claim 11, further comprising one or more light management films disposed between the lightguide and the display panel.

13. A system as recited in claim 1, wherein the first injector is non-reflectorized.

14. A system as recited in claim 1, wherein at least the first light source comprises a light emitting diode (LED).

15. A system as recited in claim 14, wherein the first light source further comprises a phosphor disposed so as to convert at least some of the light emitted by the LED at a first wavelength to light at a second wavelength different from the first wavelength.

16. A system as recited in claim 14, wherein the first plurality of light sources comprises at least a first LED capable of emitting light of a first color and at least a second LED capable of emitting light of a second color different from the first color.

17. An optical system, comprising:
a lightguide having a confinement direction;
a first plurality of light sources capable of emitting light generally about respective emission axes parallel to the confinement direction;
a first, non-reflectorized light injector disposed to couple light from the first plurality of light sources to the lightguide, the first injector directing the light from the first plurality of light sources to the lightguide.

18. A system as recited in claim 17, wherein the first light injector is shaped so that light entering the first injector is substantially all reflected towards the lightguide via one or more total internal reflections.

19. A system as recited in claim 17, wherein the first light injector has a first surface, at least a first portion of the first surface being shaped as a confinement curve for confining light from the first plurality of light sources in the confinement direction.

20. A system as recited in claim 19, wherein a second portion of the first surface is straight.

21. A system as recited in claim 19, wherein a second portion of the first surface is curved.

22. A system as recited in claim 21, wherein the second portion of the first surface comprises a parabolic surface.

23. A system as recited in claim 19, wherein the first light injector comprises a second surface, at least a portion of the second surface being straight.

24. A system as recited in claim 19, wherein the first light injector comprises a second surface, at least a portion of the second surface being curved.

25. A system as recited in claim 17, further comprising a second plurality of light sources disposed proximate a second edge of the lightguide and a solid second light injector disposed to couple light from the second plurality of light sources into the lightguide.

26. A system as recited in claim 25, wherein the second light injector has a first surface, at least a first portion of the first surface being shaped as a confinement curve for confining light from the second plurality of light sources in the confinement direction by total internal reflection.

27. A system as recited in claim 17, wherein light is extracted from the lightguide and further comprising a display panel disposed for illumination by the light extracted from the lightguide and a controller coupled to the display panel to control an image displayed by the display panel.

28. A system as recited in claim 27, further comprising one or more light management films disposed between the lightguide and the display panel.

29. A system as recited in claim 17, wherein the first plurality of light sources comprises light emitting diodes (LEDs).

30. A system as recited in claim 29, wherein at least one of the LEDs further comprises a phosphor disposed so as to convert at least some of the light emitted by the at least one of the LEDs at a first wavelength to light at a second wavelength different from the first wavelength.

31. A system as recited in claim 29, wherein the first plurality of light sources comprises at least a first LED capable of emitting light of a first color and at least a second LED capable of emitting light of a second color different from the first color.

32. An optical system, comprising:
a lightguide defining a confinement direction
a first set of one or more light sources capable of generating illumination light;
a solid first light injector disposed to couple light from the one or more light sources to the lightguide, at least a first portion of the illumination light from the one or more light sources entering the first light injector along a direction having a component directed away from the lightguide, the first portion of the illumination light being totally internally reflected within the injector.

33. A system as recited in claim 32, wherein the one or more light sources emit light generally along an emission axis parallel to the confinement direction.

34. A system as recited in claim 32, wherein the first light injector has a first surface, at least a first portion of the first surface being shaped as a confinement curve for totally internally reflecting the first portion of the illumination light.

35. A system as recited in claim 34, wherein a second portion of the first surface is straight.

36. A system as recited in claim 34, wherein a second portion of the first surface is curved.

37. A system as recited in claim 34, wherein the first light injector comprises a second surface, at least a portion of the second surface being straight.

38. A system as recited in claim 34, wherein the first light injector comprises a second surface, at least a portion of the second surface being curved.

39. A system as recited in claim 32, further comprising a second set of light sources disposed proximate a second edge of the lightguide and a solid second light injector disposed to couple light from the second set of light sources into the lightguide.

40. A system as recited in claim 39, wherein the second light injector has a first surface, at least a first portion of the first surface of the second light injector being shaped as a confinement curve for confining light from the second set of light sources in the confinement direction by total internal reflection.

41. A system as recited in claim 32, wherein light is extracted from the lightguide and further comprising a display panel disposed for illumination by the light extracted from the lightguide and a controller coupled to the display panel to control an image displayed by the display panel.

42. A system as recited in claim 41, further comprising one or more light management films disposed between the lightguide and the display panel.

43. A system as recited in claim 32, wherein the one or more light sources comprises light emitting diodes (LEDs).

44. A system as recited in claim 43, wherein at least one of the LEDs further comprises a phosphor disposed so as to convert at least some of the light emitted by the at least one of the LEDs at a first wavelength to light at a second wavelength different from the first wavelength.

45. A system as recited in claim 43, wherein the first plurality of light sources comprises at least a first LED capable of emitting light of a first color and at least a second LED capable of emitting light of a second color different from the first color.
